(19) United States
(12) Patent Application Publication
(10) Pub. No.: US 2010/0041294 A1
(43) Pub. Date: Feb. 18, 2010

(54) CORE-SHEATH FIBER, NONWOVEN AND ARTIFICAL LEATHER

(75) Inventors: Chung-Chih FENG, Jen-Wu Hsiang (TW); Chih-Yi LIN, Jen-Wu Hsiang (TW); Jui-Peng TUNG, Jen-Wu Hsiang (TW); Gao-Long YANG, Jen-Wu Hsiang (TW); Szu-Wei HUANG, Jen-Wu Hsiang (TW); Ti-Shun YEH, Jen-Wu Hsiang (TW); Kuo-Hsin CHIEN, Jen-Wu Hsiang (TW)

Correspondence Address: PATENTTM.US, P. O. BOX 82788, PORTLAND, OR, 97282-0788, US

(73) Assignee: SAN FANG CHEMICAL INDUSTRY CO., LTD., Jen-Wu Hsiang (TW)

(21) Appl. No.: 12/249,836

(22) Filed: Oct. 10, 2008

(30) Foreign Application Priority Data
Aug. 18, 2008 (TW) 097131393

(51) Int. Cl. B32B 5/02; D04H 13/00

(52) U.S. Cl. 442/335; 428/367

(57) ABSTRACT

A core-sheath fiber has a core and a sheath. The core comprises 0.1 to 10 wt % of carbon black pigment particles. The sheath surrounds the core preventing the core from being exposed. Because the carbon black pigment particles are mainly distributed in the core and the core is surrounded by the sheath with little or no carbon black pigment particles, a surface of the core-sheath fiber has low friction and electrical conductivity. Therefore, a lifetime of a punch needle used in machinery to produce a nonwoven is maintained and the nonwoven can undergo high frequency treatment to form artificial leather. Additionally, the sheath has little or no carbon black pigment particles, so the sheath is improved compatibility with polyurethane (PU) used for high frequency treatment.

### BACKGROUND OF THE INVENTION

1. Field of Invention

The present invention relates to a core-sheath fiber, and more particularly to a core-sheath fiber with a core and a sheath surrounding the core, improving life of machinery used in production thereof and being easily treated by high frequency treatment.

2. Description of the Related Art

Natural leather requires farming and growth of cattle for slaughter, is environmentally intensive and may be objected to on ethical grounds. Furthermore, appearance, contact, strength and the like of synthetic leather are similar to those of natural leather but synthetic leather is much cheaper.

Synthetic leather comprises a substrate that is usually fiber. The substrate of artificial leather, a specific synthetic leather, is a nonwoven substrate having similar composition to natural leather and gives the artificial leather a soft and fine porous structure and may be used to produce clothes, shoes, purses, gloves or the like.

However, black artificial leather requires carbon black pigment particles to be added to the nonwoven substrate. Because the carbon black pigment particles are hard, during production of the nonwoven substrate, a punch needle contacts the carbon black pigment particles and is worn down and has a reduced lifetime. Furthermore, carbon black pigment particles are electrically conductive so interfere with high frequency electrical treatment used to bond the nonwoven substrate.

TW 200600336 discloses a high frequency-weldable substrate, that may be fiber. The substrate has a weldable area on a surface of the substrate being modified poly(ethylene terephthalate) (PET) to control a melting point of the surface of the structure allowing the high frequency treatment to be implemented successfully. However, the fiber in this patent does not contain carbon black pigment particles so may not be able to be colored using this pigment. TW 200722564 discloses a polyester (PE) monofilament. The PE monofilament has a core-sheath structure. Viscosity of the core of the monofilament is controlled. The sheath of the monofilament is made of PET and contains metal micro-particles or pigment particles. Therefore, the monofilament has improved dimensional stability, inhibition of filament scraping, prevention of pim contraction and prevention of halation. The monofilament is used as a screen on printed circuit board (PCB). However, the pigment particles in this patent are distributed in the sheath so the carbon black pigment particles still contact the punch needle and also interfere with the high frequency treatment. Therefore, the foregoing disadvantages still exist.

Demands of the artificial leather are increased, but the foregoing disadvantages of fibers containing carbon black pigment particles so far are not dissolved. To overcome the shortcomings, the present invention provides core-sheath fiber, nonwoven and artificial leather to mitigate or obviate the aforementioned.

### SUMMARY OF THE INVENTION

The first objective of the present invention is to provide a core-sheath fiber with a core and a sheath surrounding the core, wherein the core is impregnated with carbon black pigment particles, being used for production of a nonwoven that may be implemented in artificial leather production yielding improved production machinery life and allowing high frequency electrical bonding.

The core-sheath fiber in accordance with the present invention has a core and a sheath. The core comprises 0.1 to 10 wt % carbon black pigment particles. The sheath surrounds the core to prevent the core from being exposed.

The nonwoven in accordance with the present invention comprises at least 20 wt % of said core-sheath fibers.

The artificial leather in accordance with the present invention comprises a substrate being made from said nonwoven.

Because the carbon black pigment particles are mainly distributed in the core and the core is surrounded by the sheath having little or no carbon black pigment particles, a surface of the core-sheath fiber has low friction and electrical conductivity. Therefore, a lifetime of a punch needle used in machinery to produce the nonwoven is maintained and the nonwoven can undergo high frequency treatment to form artificial leather. Additionally, the sheath has little or no carbon black pigment particles, so the sheath has improved compatibility with polyurethane (PU) used for high frequency treatment.

Other objectives, advantages and novel features of the invention will become more apparent from the following detailed description when taken in conjunction with the accompanying drawings.

### BRIEF DESCRIPTION OF THE DRAWINGS

FIG. 1 is a cross sectional end view of a core-sheath fiber in accordance

### DETAILED DESCRIPTION OF THE INVENTION

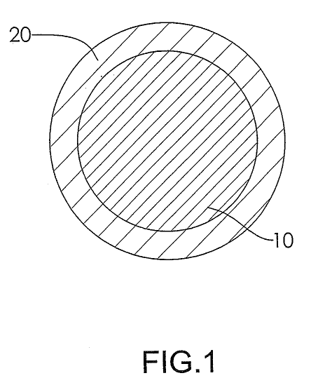

With reference to FIG. 1, a core-sheath fiber in accordance with the present invention has a core (10) and a sheath (20) and a cross section. The cross section of the core-sheath fiber may be circular, oval, polygonal (such as triangular, quadrangular or the like) or irregular. Preferably, the cross section of the core-sheath fiber is circular to obtain good fiber-forming and mechanical properties such as strength, hardness, ductility, stiffness and the like.

The core (10) has 0.1 to 10 wt % of carbon black pigment particles (11). A diameter of each carbon black pigment particle (11) is between 0.01 to 5 μm. A preferable diameter of each carbon black pigment particle (11) is between 0.5 to 2 μm.

The sheath (20) surrounds the core (10) to prevent the core (10) from being exposed.

Preferably, the core-sheath fiber contains 10 to 90 wt % of the core (10) and 10 to 90 wt % of the sheath (20). When the core-sheath fiber contains less than 10 wt % of the core (10), the core-sheath fiber will be light colored. When the core-sheath fiber contains more than 90 wt % of the core (10), the sheath (20) may not surrounded the core (10), so the core (10) may be exposed. Most preferably, the core-sheath fiber contains 30 to 70 wt % of the core (10) and 30 to 70 wt % of the sheath (20), which can be treated to obtain a desired nonwoven and artificial leather.

Preferably, the core (10) consists of carbon black pigment particles (11) and at least 90 wt % of fibers selected from the group consisting of polyester (PE), polyamide (PA) and polyolefin.

The sheath (20) consists of additives and at least 80 wt % of fibers selected from the group consisting of polyester, polyamide and polyolefin.

Fibers of the core (10) and the sheath (20) may be the same or different.

Polyester is selected from the group consisting of poly(ethylene terephthalate) (PET), poly(trimethylene terephthalate) (PTT), poly (butylene terephthalate) (PBT) and copolymer containing at least two materials selected from poly(ethylene terephthalate) (PET), poly(trimethylene terephthalate) (PTT) and poly (butylene terephthalate) (PBT).

Polyamide is selected from the group consisting of PA 6, PA 6.6, PA 12 and copolymer containing at least two materials selected from PA 6, PA 6.6, PA 12.

Polyolefin is selected from the group consisting of polyethylene, poly propylene and a copolymer thereof.

Additives of the sheath (20) are less than 20 wt % of the sheath (20) and include carbon black pigment particles (11), antioxidants, antiseptics, ultraviolet (UV) absorbers, retardants, stabilizers, compatilizers and the like. When the additives of the sheath (20) include carbon black pigment particles (11), the carbon black pigment particles (11) are between 0.01 to 1 wt % of the sheath (20) for coloring. The present invention also relates to a nonwoven. The nonwoven in accordance with the present invention comprises at least 20 wt % of the core-sheath fibers. The present invention further relates to artificial leather. The artificial leather in accordance with the present invention comprises a substrate being the nonwoven comprising at least 20 wt % of the core-sheath fibers.

Because the carbon black pigment particles (11) are principally distributed in the core (10) and the core (10) is surrounded by the sheath (20) with little or no carbon black pigment particles (11), a surface of the core-sheath fiber has a low friction and low electrical conductivity. Therefore, a lifetime of a punch needle used for producing the nonwoven is maintained and the nonwoven is easily treated by high frequency treatment to form the artificial leather. Additionally, the sheath (20) has little or no carbon black pigment particles, so the sheath (20) is more compatible with polyurethane (PU) used in the high frequency treatment than fibers treated with carbon black.

Furthermore, content of the carbon black pigment particles (11) in the core-sheath fiber of the present invention is lower than that in a conventional fibers, so the core-sheath fiber of the present invention has improved physical properties that improve a texture of the nonwoven.

The core (10) and the sheath (20) may be formed by melt spinning and staple fiber spinning. At least 20 wt % of the core-sheath staple fiber and less than 80 wt % of other fibers (such as polyester fiber, polyamide fiber or polyolefin) are mixed before spinning. Various methods can be used to bond the core-sheath fibers and other fibers to become the nonwoven including, but not limited to needle punching, water punching, needle and water punching, spin bonding, spin bonding and needle punching, spin bonding and water punching, thermo-bonding, chemical bonding or other methods.

The nonwoven is the substrate of the artificial leather. The nonwoven is immersed in polyurethane, is coated with resin, is adhered to other substrates or other treatments to form the artificial leather.

The methods for producing nonwoven and artificial leather are well known by those skilled in the art. Specifically, the core (10) of the present invention contains carbon black pigment particles (11). Therefore, the nonwoven and the artificial leather using the present invention can be formed by any method that is known by those skilled in the art. Because the carbon black pigment particles (11), that are electrically conductive and wear down punch needles are mainly included in the core (10), the core-sheath fiber of the present invention can be used with any method without adversely damaging machinery. Therefore, the present invention has a significant contribution to related industries.

### EXAMPLES

The following examples present methods for producing the present invention and properties of the present invention. Such examples are illustrative only, and no limitation on present invention is meant thereby.

With reference to Table 1, showing properties and methods used for testing in accordance with the American Society For Testing and Materials (ASTM).

TABLE 1
Experimental method

| | |
|---|---|
| Tearing Strength | ASTM D2262 |
| | ASTM D1117 |
| Tensile Strength | ASTM D1682 |
| | ASTM D1117 |
| Elongation | ASTM D1682 |
| | ASTM D1117 |
| Softness | ST 300 |
| Mullen Burst | ASTM D3786 |
| Peeling Strength | SATRA TM410 |
| Basic Weight | ASTM D3776 |
| Thickness | ASTM D1117 |

### Example 1

1. The Core-Sheath Fiber was Produced by Melt Spinning

Material A used for the core and material B used for the sheath were provided, wherein material A and material B were poly(ethylene terephthalate) (PET) with intrinsic viscosity of 0.65, as produced by Shinkong Synthetic Fiber Corp., Taiwan. Weight ratios of the core and the sheath were respectively 60 wt % and 40 wt %. Carbon black pigment particles were mixed in material A at a concentration of 3 wt %. A diameter of each carbon black pigment particle was 1 μm. The materials A and B were dried at 140° C. for 5 hours and then extrusion molded to form the core-sheath filament (melting point 290° C.). The core-sheath filament was drawn from a core-sheath spinneret. The core-sheath filament had a denier of 12 den, tensile strength of 1.5 g/den and elongation of 600%.

Finally, the core-sheath filament was treated by staple fiber spinning to elongate the core-sheath filament 4.2 times by hot drawing to obtain a core-sheath staple fiber with denier of 3 den, length of 64 mm, tensile strength of 5.20 g/den and elongation of 62.4 %.

With reference to table 2, the core-sheath staple fiber of the present invention was compared with a conventional black polyester (PE) staple fiber that was purchased from Far Eastern Textile Co. Ltd, Taiwan.

TABLE 2
Properties of Staple Fiber

| | Tensile Strength | Elongation |
|---|---|---|
| Staple fiber | (ASTM D1577) | (ASTM D1577) |
| The present invention | 5.20 g/den | 62.4% |
| Black PE staple fiber | 4.60 g/den | 52.7% |

According to table 2, the core-sheath staple fiber had improved tensile strength and elongation over the conventional black PE staple fiber.

2 The Core-Sheath Staple was Needle Punched to Form a Nonwoven

The core-sheath staple fiber, black polyester (PE) staple fiber with denier of 3 den and white polyester (PE) staple fiber with denier of 3 den were in a ratio of 1:1:1 and were treated by a carding machine and a cross lapping machine to form a web. The web was needle punched with a needle density of 1200 strokes/cm² then was thermal pressed to shape the web before being calendered by a calendering machine at 180° C. to obtain a nonwoven. The nonwoven has a basic weight of 260 g/m², a thickness of 0.8 mm, a width of 58 inch and apparent density of 0.325 g/cm³. The nonwoven could be used as a substrate of artificial leather.

With reference to table 3, the core-sheath staple fiber, a black PE staple fiber and a white polyester staple fiber were needle punched until terminal failure of punch needles to test respective lifetimes of the punch needles used in processing the staple fibers.

TABLE 3
Life of punch needle

| Species of Staples | Terminal failure |
|---|---|
| The present invention | 15 million times |
| Black PE staple fiber | 12 million times |
| White PE staple fiber | 15 million times |

According to table 3, comparing white and lack PE fibers, because carbon black pigment particles are exposed on a surface of the black PE staple fiber, the punch needle directly contacted the carbon black pigment particles and failed faster than expected for white PE fibers. However, the core-sheath staple fiber of the present invention prevents the punch needle from directly contacting the carbon black pigment particles, therefore, the lifetime of the punch needle used for the core-sheath staple fiber was maintained and substantially equal to the lifetime of the punch needle used for the white PE staple fiber.

With reference to table 4., the nonwoven of the present invention and a conventional polyethylene terephthalate (PET) nonwoven (SN-2362BK, purchased from Far Eastern Textile Co. Ltd, Taiwan), respectively labeled A and B had their properties tested, wherein each property was tested twice.

TABLE 4
Properties of nonwoven

| | | | Tearing | Tensile | | Peeling | | Basic | | Mullen |
|---|---|---|---|---|---|---|---|---|---|---|
| Species | | | Strength | Strength | Elongation | Strength | | Weight | Thickness | Burst |
| of nonwoven | | | (kg) | (kg) | (%) | (kg) | Softness | (g/m²) | (mm) | (kg) |
| A | I | T | 13.8 | 29.1 | 82 | 18.8 | 3.8 | 260 | 0.80 | 22 |
| | | Y | 11.7 | 31.7 | 98 | | | | | |
| | II | T | 15.3 | 32.6 | 85 | 18.0 | 3.6 | 258 | 0.78 | 22 |
| | | Y | 12.9 | 32.5 | 99 | | | | | |
| B | I | T | 13.0 | 28.5 | 80 | 18.6 | 3.2 | 250 | 0.82 | 18 |
| | | Y | 11.7 | 26.6 | 119 | | | | | |
| | II | T | 13.1 | 30.2 | 79 | 19.6 | 3.1 | 265 | 0.83 | 20 |
| | | Y | 11.2 | 28.1 | 111 | | | | | |

T: machine direction(MD), i.e. longitude
Y: cross direction (CD), i.e. latitude

According to Table 4, the nonwoven of the present invention has excellent tearing strength, tensile strength, elongation and mullen burst properties.

With reference to Table 5, the core-sheath staple fiber of the present invention and the conventional black PE staple fiber were treated with high frequency treatment under the same conditions to compare mechanical properties of those staple fibers.

TABLE 5
High frequency treatment

| Staple fibers (260 g/m²) | Conditions | Observations |
|---|---|---|
| The present invention | 150° C. | Normal |
| | 93 Hz/4 min | |
| Black PE staple fiber | 150° C. | Sparking |
| | 93 Hz/4 min | |

According to table 5, the present invention successfully prevents electrical conductivity of the carbon black pigment particles from interfering with high frequency treatment since no sparking occurred. Therefore, the core-sheath staple fiber of the present invention is shown to be easily treated by high frequency treatment.

3 The Nonwoven was Treated to Form Artificial Leather

The nonwoven served as a substrate and was immersed into polyurethane (PU) resin, was further coated with PU resin on a surface of the nonwoven, then was laminated onto a backing material using adhesive to obtain an artificial leather.

With reference to Table 6, properties of the artificial leather of the present invention in this example and those of an artificial leather made of a nonwoven comprising 100 wt % black PE staple fibers were respectively tested as A and B and compared, wherein L, M, R, A respectively refer to areas tested being the left, middle, right and an averaged value and T and Y respectively refer to machine direction (MD), i.e. longitude and cross direction (CD), i.e. latitude.

According to table 6, the artificial leather of the present invention has superior peeling strength and tensile strength when compared to the conventional artificial leather. Other properties of the artificial leather of the present invention are similar to those of the conventional artificial leather.

TABLE 6
Properties of artificial leathers

| | | | | | | Tensile | | Tearing | | | |
|---|---|---|---|---|---|---|---|---|---|---|---|
| | | | Basic | | Peeling | Strength | | Strength | | Elongation | |
| | | Thickness | Weight | | Strength | (kg/inch) | | (kg) | | (%) | |
| | | (mm) | (g/m²) | Softness | (N/cm) | T | Y | T | Y | T | Y |
| A | L | 1.32 | 492 | 2.7 | 4.0 | 43 | 47 | 12.4 | 13.4 | 77 | 93 |
| | M | 1.28 | 488 | 2.6 | 4.1 | 42 | 47 | 12.4 | 13.1 | 78 | 96 |
| | R | 1.25 | 471 | 2.6 | 4.2 | 41 | 49 | 12.5 | 13.4 | 70 | 95 |
| | A | 1.28 | 484 | 2.6 | 4.1 | 42 | 48 | 12.4 | 13.3 | 75 | 95 |
| B | L | 1.23 | 488 | 2.6 | 3.6 | 43 | 39 | 13.2 | 11.9 | 63 | 95 |
| | M | 1.26 | 469 | 2.6 | 3.8 | 41 | 37 | 12.7 | 11.5 | 61 | 97 |
| | R | 1.25 | 472 | 2.5 | 3.7 | 40 | 41 | 12.9 | 11.8 | 65 | 97 |
| | A | 1.25 | 476 | 2.6 | 3.7 | 41 | 39 | 12.9 | 11.7 | 63 | 96 |

### Example 2

The core-sheath staple fiber is produced by example 1-1. 100 wt % of the core-sheath staple fiber was treated by a carding machine and a cross lapping machine to form a web. The web was needle punched with a needle density of 1200 strokes/cm², then thermal pressed to shape the web before being calendered by a calendering machine at 180° C. to obtain a nonwoven. The nonwoven has a basic weight of 260 g/m², a thickness of 0.9 mm, a width of 58 inch and apparent density of 0.322 g/cm³. The nonwoven could be used as a substrate of artificial leather.

Wither reference to Table 7, properties of the nonwoven of the present invention in this example and those of the conventional polyethylene terephthalate (PET) nonwoven (SN-2362BK, purchased from Far Eastern Textile Co. Ltd, Taiwan) were tested respectively as A and B, wherein each property was tested twice and T and Y respectively refer to machine direction (MD), i.e. longitude and cross direction (CD), i.e. latitude.

TABLE 7
Properties of nonwoven

| | | | Tearing | Tensile | | Peeling | | Basic | | Mullen |
|---|---|---|---|---|---|---|---|---|---|---|
| Species of | | | Strength | Strength | Elongation | Strength | | Weight | Thickness | Burst |
| nonwoven | | | (kg) | (kg) | (%) | (kg) | Softness | (g/m²) | (mm) | (kg) |
| A | I | T | 12.8 | 39.4 | 71 | 18.4 | 3.5 | 294 | 0.92 | 22 |
| | | Y | 11.6 | 33.4 | 117 | | | | | |
| | II | T | 12.8 | 36.4 | 77 | 18.0 | 3.6 | 286 | 0.90 | 22 |
| | | Y | 12.5 | 32.4 | 115 | | | | | |
| B | I | T | 13.2 | 33.4 | 78 | 17.7 | 3.3 | 300 | 0.92 | 23 |
| | | Y | 10.9 | 31.4 | 102 | | | | | |
| | II | T | 14.1 | 32.6 | 77 | 16.9 | 3.1 | 301 | 0.90 | 23 |
| | | Y | 11.7 | 30.8 | 99 | | | | | |

According to Table 7, the nonwoven with 100 wt % of the core-sheath staple fiber has excellent tensile, strength elongation and peeling strength.

### Example 3

Weight ratios of a core and a sheath were respectively 60 wt % and 40 wt %. The core is poly(ethylene terephthalate) (PET) with an intrinsic viscosity of 0.65, which were produced from Shinkong Synthetic Fiber Corp., Taiwan and the sheath is polyamide 6 (PA 6). The core contains carbon black pigment particles have a concentration of 3 wt %. A diameter of each carbon black pigment particle is 1 μm. The core and the sheath were extrusion molded to form the core-sheath filament (melting point about 300° C.). The core-sheath filament was drawn from a core-sheath spinneret. The core-sheath filament had a denier of 12 den, tensile strength of 1.5 g/den and elongation of 600%.

Finally, the core-sheath filament was treated by staple fiber spinning to elongate the core-sheath filament by 4.2 times by hot drawing to obtain a core-sheath staple fiber with denier of 3 den, length of 51 mm, tensile strength of 4.7 g/den and elongation of 50%.

### Example 4

Weight ratios of a core and a sheath were respectively 60 wt % and 40 wt %. The core was polyamide 6 (PA 6) and the sheath was poly(ethylene terephthalate) (PET) with an intrinsic viscosity of 0.65, which were produced from Shinkong Synthetic Fiber Corp., Taiwan. The core contained carbon black pigment particles in a weight ratio of 3 wt %. A diameter of each carbon black pigment particle was 1 μm. The core and the sheath were extrusion molded to form the core-sheath filament (melting point about 300° C.). The core-sheath filament was drawn from a core-sheath spinneret. The core-sheath filament has denier of 12 den, tensile strength of 1.5 g/den and elongation of 600%.

Finally, the core-sheath filament was treated by staple fiber spinning to elongate the core-sheath filament by 4.2 times by hot drawing to obtain a core-sheath staple fiber with denier of 3 den, length of 51 mm, tensile strength of 4.5 g/den and elongation of 50%.

### Example 5

Weight ratios of a core and a sheath were respectively 60 wt % and 40 wt %. The core and the sheath were both poly(ethylene terephthalate) (PET) with an intrinsic viscosity of 0.65, which were produced from Shinkong Synthetic Fiber Corp., Taiwan. The core contained carbon black pigment particles in a weight ratio of 3 wt % and anti-bacterial silver particles. A diameter of each carbon black pigment particle was 1 μm and a diameter of each Ag particle was 1 μm. The core and the sheath were extrusion molded to form the core-sheath filament (melting point about 300° C.). The core-sheath filament was drawn from a core-sheath spinneret. The core-sheath filament has denier of 12 den, tensile strength of 1.5 g/den and elongation of 600%.

Finally, the core-sheath filament was treated by staple fiber spinning to elongate the core-sheath filament by 4.2 times by hot drawing to obtain an anti-bacterial core-sheath staple fiber with denier of 3 den, length of 51 mm, tensile strength of 4.5 g/den and elongation of 50%.

### Example 6

100 wt % of the core-sheath staple fibers in examples 3 to 5 and a conventional polyethylene terephthalate (PET) nonwoven (SN-2362BK, purchased from Far Eastern Textile Co. Ltd, Taiwan) were respectively treated by a carding machine and a cross lapping machine to form a web. The web with a needle density of 1200 strokes/cm² was needle punched, then was thermal pressed to shape the web before being calendered by a calendering machine at 180° C. to obtain four nonwoven materials. Each nonwoven had a basic weight of 260 g/m², a thickness of 0.8 mm, a width of 58inch and apparent density of 0.325 g/cm³. The nonwoven could be used as a substrate for artificial leather.

With reference to Table 8, properties of the nonwovens made by the staple fibers in example 2 to 5 and the conventional PET nonwoven were tested and compared.

TABLE 8
Comparative result of nonwovens

| | Item | | | |
|---|---|---|---|---|
| | | | | Durability for |
| | Staple | Nonwoven | Lifetime of | high frequency |
| Nonwoven | properties | properties | punch needle | treatment |
| Example 2 | ◯ | ◯ | ◯ | ◯ |
| Example 3 | ◯ | ◯ | ◯ | ◯ |
| Example 4 | ◯ | ◯ | ◯ | ◯ |
| Example 5 | ◯ | ◯ | ◯ | ◯ |
| conventional | Δ | Δ | X | X |
| PET nonwoven | | | | |

Note:
◯ excellent
Δ normal
X poor

The carbon black pigment particles are added in the core of the present invention, so the properties of the staples and the nonwovens of the present invention are superior to those of the conventional PET nonwoven materials. Since the conventional PET staple has more black pigment particles, the PET staple is brittle and has poor properties, which cause the PET nonwoven to also perform poorly.

Regarding lifetimes of punch needles used for different staple fibers, since the staple fibers of the conventional PET nonwoven had exposed carbon black pigment particles, the punch needle used for the conventional staple fibers was easily worn out. Therefore, the punch needle used for the core-sheath staple fibers of the present invention has an improved lifetime.

Because the core-sheath staple fibers in example 2 to 5 had no electrical conductivity, the high frequency treatment was easily proceeded. Contrary to the example 2 to 5, the exposed carbon black pigment particles of the conventional staple fibers caused the conventional staple fibers to have electrical conductivity. Consequently, the conventional PET nonwoven has poor durability for high frequency treatment.

### Example 7

Nonwovens as produced in example 6 served as a substrate and were respectively immersed into a polyurethane (PU) resin, were further coated with PU resin on a surface of the nonwoven and then were laminated onto a backing material to obtain artificial leathers.

With reference to Table 9, properties of the artificial leathers made from the nonwovens in example 6 were tested and compared.

TABLE 9
Comparative result of artificial leathers

Item

| | | Durability for high |
|---|---|---|
| Artificial leather | Properties | frequency treatment |
| Example 2 | ◯ | ◯ |
| Example 3 | ◯ | ◯ |
| Example 4 | ◯ | ◯ |
| Example 5 | ◯ | ◯ |
| Conventional artificial leather | Δ | X |

Note:
◯ excellent
Δ normal
X poor

As shown previously, the carbon black pigment particles are added in the core of the present invention and the core is surrounded by the sheath, so the core-sheath staple fiber, the nonwoven and the artificial leather of the present invention have excellent properties and will not interfere with the high frequency treatment.

Even though numerous characteristics and advantages of the present invention have been set forth in the foregoing description, together with details of the structure and function of the invention, the disclosure is illustrative only. Changes may be made in detail, especially in matters of shape, size and production of the invention to the full extent indicated by the broad general meaning of the terms in which the appended claims are expressed.

What is claimed is:

1. A core-sheath fiber comprising:
a core having 0.1 to 10 wt % of carbon black pigment particles; and
a sheath surrounding the core preventing the core from being exposed.

2. The core-sheath fiber as claimed in claim 1, wherein the core-sheath fiber contains 10 to 90 wt % of the core.

3. The core-sheath fiber as claimed in claim 2, wherein the sheath comprises 0.01 to 1 wt % carbon black pigment particles.

4. The core-sheath fiber as claimed in claim 1, wherein the core is at least 90 wt % of fibers selected from the group consisting of polyester, polyamide and polyolefin; and
the sheath is at least 80 wt % fibers selected from the group consisting of polyester, polyamide and polyolefin.

5. The core-sheath fiber as claimed in claim 1, wherein
the core is at least 90 wt % fibers selected from the group consisting of polyester, polyamide and polyolefin; and
the sheath is at least 80 wt % fibers selected from the group consisting of polyester, polyamide and polyolefin.

6. The core-sheath fiber as claimed in claim 1, wherein a cross section of the core-sheath fiber is circular.

7. The core-sheath fiber as claimed in claim 1, wherein a cross section of the core-sheath fiber is polygonal.

8. The core-sheath fiber as claimed in claim 1, wherein a cross section of the core-sheath fiber is irregular.

9. The core-sheath fiber as claimed in claim 1, wherein a diameter of each carbon black pigment particle is between 0.01 to 5 μm.

10. A nonwoven comprises at least 20 wt % of core-sheath fibers, wherein the core-sheath fibers have
a core having 0.1 to 10 wt % of carbon black pigment particles;
a sheath surrounding the core preventing the core from being exposed.

11. The nonwoven as claimed in claim 10, wherein the nonwoven is made by treating the core-sheath fibers with a method selected from needle punching, water punching, needle and water punching, spin bonding, spin bonding and needle punching, spin bonding and water punching, thermo-bonding and chemical bonding.

12. The nonwoven as claimed in claim 10, wherein the core-sheath fiber contains 10 to 90 wt % of the core.

13. The nonwoven as claimed in claim 10, wherein the sheath comprises 0.01 to 1 wt % carbon black pigment particles.

14. The nonwoven as claimed in claim 10, wherein
the core is at least 90 wt % fibers selected from the group consisting of polyester, polyamide and polyolefin; and
the sheath is at least 80 wt % fibers selected from the group consisting of polyester, polyamide and polyolefin.

15. The nonwoven as claimed in claim 10, wherein a diameter of each carbon black pigment particle is between 0.01 to 5 μm.

16. An artificial leather comprises a substrate being a nonwoven comprising at least 20 wt % of core-sheath fibers, wherein the core-sheath fibers have
a core having 0.1 to 10 wt % of carbon black pigment particles;
a sheath surrounding the core preventing the core from being exposed.

17. The artificial leather as claimed in claim 16, wherein the nonwoven is made by treating the core-sheath fibers with a method selected from needle punching, water punching, needle and water punching, spin bonding, spin bonding and needle punching, spin bonding and water punching, thermo-bonding and chemical bonding.

18. The artificial leather as claimed in claim 16, wherein the core-sheath fiber contains 10 to 90 wt % of the core.

19. The artificial leather as claimed in claim 16, wherein the sheath comprises 0.01 to 1 wt % carbon black pigment particles.

20. The artificial leather as claimed in claim 16, wherein
the core is at least 90 wt % fibers selected from the group consisting of polyester, polyamide and polyolefin; and
the sheath is at least 80 wt % fibers selected from the group consisting of polyester, polyamide and polyolefin.
